(19) United States
(12) Patent Application Publication
(10) Pub. No.: US 2024/0369992 A1
(43) Pub. Date: Nov. 7, 2024

(54) Pressurized Solution Extraction System and Method

(71) Applicant: Eric Matthew Bodenchak, Los Angeles, CA (US)

(72) Inventor: Eric Matthew Bodenchak, Los Angeles, CA (US)

(21) Appl. No.: 18/654,647

(22) Filed: May 3, 2024

Related U.S. Application Data
(60) Provisional application No. 63/499,976, filed on May 3, 2023.

(51) Int. Cl. G05B 19/4155

(52) U.S. Cl. CPC G05B 19/4155; G05B 2219/32287

(57) ABSTRACT

A Pressurized Solution Extraction System and Method is disclosed herein. The pressurized solution extraction system comprises a cylinder and a piston, a locking mount connected to the end of the cylinder, a solute container having a plurality of holes and an interior diameter matching the that of the cylinder and in pressure contact to the end of the cylinder by the locking mount to create a chamber capable of holding a solute/solvent mix, a pressure sensor connected to the assembly and capable of taking pressure measurements of the solute/solvent mix, an actuator connected to the extraction chamber assembly, held in axial alignment by a frame, controlled by an actuator controller unit and a microcontroller in electronic communication with the pressure sensor, with the piston operating in a linear direction through the cylinder to force the solute/solvent mix through the solute container as directed by the microcontroller.

### CROSS-REFERENCE TO RELATED APPLICATIONS

The present application claims priority to the U.S. Provisional Patent Application Ser. No. 63/499,976 filed on May 3, 2023 and titled Mechanically-Driven, PID-Controlled Compound Extraction Machine and Method of Operation, the contents of which are incorporated herein by reference in their entirety.

### BACKGROUND

A pressurized solution extraction system is a device used to separate soluble extractants from insoluble material. This process has utility in multiple fields including, but not limited to, food and beverage preparation, biochemistry, synthetic biology, and chemistry.

The elevated temperature and pressure inside a pressurized solution extraction system has a significant effect on the solubility of many materials, thus improving extraction speed and efficiency.

Because solutes are expressed from the material to be extracted at different rates dependent on pressure and temperature, the end composition of the solution can vary wildly given the same inputs. By carefully modulating the pressure and temperature throughout the extraction process, the degree of control over the final product is greatly increased.

This process is used in many products both at home and commercially. Espresso is just one familiar example of a product created using this process. Changing the pressure or temperature at which espresso is extracted from coffee grounds changes the composition of the resultant solution. For many, this is readily apparent in the form of taste and aroma. Many existing solutions in the espresso field do not offer variability in pressure once the extraction process has started. For many existing solutions, making a change to the operational pressure is a lengthy and involved process that cannot be performed while the machine is running. Those that are able to offer pressure variability through the extraction process suffer from excessive hysteresis due to the inability of the pump to quickly change output pressure, or due to methods of pressure measurement that do not directly measure pressure in the extraction chamber, introducing error to their control algorithm.

In the domain of food and beverage preparation, this process can also be used to make extracts from a variety of aromatics, allowing the rapid, on demand creation of extracts for use in baking, cocktail creation, or infused liquors. A pressurized solution extraction system can be configured to work with a variety of solvents and extractable materials. It is more versatile than existing solutions and offers a greater granularity and precision than existing solutions.

This background information is provided to reveal information believed by the applicant to be of possible relevance to the present invention. No admission is necessarily intended, nor should be construed, that any of the preceding information constitutes prior art against the present invention.

### SUMMARY

One aspect of the present disclosure relates to a pressure solution extraction system. The system may include a cylinder and a piston, the cylinder having an interior diameter sized to the piston, a locking mount sized to the interior diameter of the cylinder connected to the opposing end of the cylinder to that of the piston, a solute container having a plurality of holes and an interior diameter matching the interior diameter of the cylinder, a pressure sensor connected to the extraction chamber assembly, an actuator connected to the extraction chamber assembly, the motor controlled by an actuator controller unit; a frame connected to the extraction chamber assembly and actuator assembly, the frame holding the extraction chamber assembly and actuator assembly in axial alignment; and a microcontroller in electronic communication with the pressure sensor, configured to provide a signal to the actuator controller circuit, with the piston operating in a linear direction through the cylinder to force the solute/solvent mix through the solute container as directed by the microcontroller based on the pressure measurements from the pressure sensor.

In some implementations, the system may further include a temperature sensor connected to the extraction chamber assembly and capable of taking temperature measurements of the solute/solvent mix within the chamber.

In some implementations, the system may further include a user control interface in communication with the microcontroller, and a display connected to the user control interface, the user control interface allowing a user to input at least one parameter and the display showing the parameter to the user.

In some implementations, the system may further include a solvent container connected to the extraction chamber assembly such that solvent may flow from the solvent container into the extraction chamber, and a heating element connected to the solvent container and the microcontroller, the heating element further including a second temperature sensor configured to regulate the temperature of the solvent container as a result of instruction by the microcontroller.

In some implementations, the system may further include a user control interface in communication with the microcontroller, and a display connected to the user control interface, the user control interface allowing a user to input at least one operational parameter and the display showing the parameter to the user.

In some implementations, the system may further include a user control interface in communication with the microcontroller, and a display connected to the user control interface, the user control interface allowing a user to input at least one tuning parameter and the display showing the parameter to the user.

In some implementations, the system may extract solute from the solvent solute mix at a set target based on the operational parameter.

In some implementations, the microcontroller performs tracking calculations with different coefficients based on the tuning parameter.

Another aspect of the present disclosure relates to a method for operating a pressure solution extraction system comprising a cylinder, a piston, a locking mount sized to the interior diameter of the cylinder, a solute container having a plurality of holes and an interior diameter matching the interior diameter of the cylinder, the solute container configured to be in pressure contact to the end of the cylinder by the locking mount to create a chamber capable of holding a solute/solvent mix, with the cylinder, piston, and solute container comprising an extraction chamber assembly, a pressure sensor connected to the extraction chamber assembly and capable of taking pressure measurements of the solute/solvent mix within the chamber; an actuator connected to the extraction chamber assembly, the actuator controlled by an actuator controller unit; and a microcontroller in electronic communication with the pressure sensor, the microcontroller configured to provide a signal to the actuator controller circuit. The method may include the steps of: placing a solvent/solute mixture into the solute container, connecting the solute container to the cylinder with the locking mount, inputting at least one parameter into the microcontroller, extracting the solute/solvent mix thru the solute container as a result of the operational parameter.

In some implementations, the method may further include the step of inputting at least one parameter into the user control interface.

In some implementations, the method may further include the steps of filling a solvent container with a solvent to be used for extraction, and inputting a desired solvent container temperature to the microcontroller

In some implementations, the method may further include the steps of filling the solvent container with a solvent to be used for extraction, and inputting a desired solvent container temperature to the user control interface

In some implementations, the method may further include the step of inputting at least one operational parameter into the user control interface.

In some implementations, the method may further include the step of inputting at least one tuning parameter into the user control interface.

In some implementations, the method may further include the step of setting a target based on the operational matter.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF FIGURES

FIG. 1 illustrates an exemplary angled overall view of a pressurized solution extraction system 100.

FIG. 1A illustrates an exemplary angled overall view of a pressurized solution extraction system 100 with a single-leg frame 102.

FIGS. 2 and 2A illustrate an exemplary angled overall slice view of a pressurized solution extraction system 100.

FIG. 3 illustrates an exemplary overall slice view of a pressurized solution extraction system 100.

FIG. 4 illustrates an exemplary side slice view of a solution extraction chamber assembly 110.

FIG. 5 illustrates a lower angled view of the cylinder 112.

FIG. 6 illustrates an exemplary bottom view of a solution extraction chamber assembly 110.

FIG. 7 illustrates a lower angled view of a solute container 120.

FIG. 8 illustrates an exemplary angled slice view of a solution extraction chamber assembly piston 114.

FIG. 9 is a screenshot of a pressure profile programming section of the user interface 300 for a pressurized solution extraction system 100 and method 200 in accordance with one or more embodiments.

FIGS. 10A, 10B, 10C, and/or 10D illustrate a method 200 of operating a pressurized solution extraction system, in accordance with one or more implementations.

### DESCRIPTION

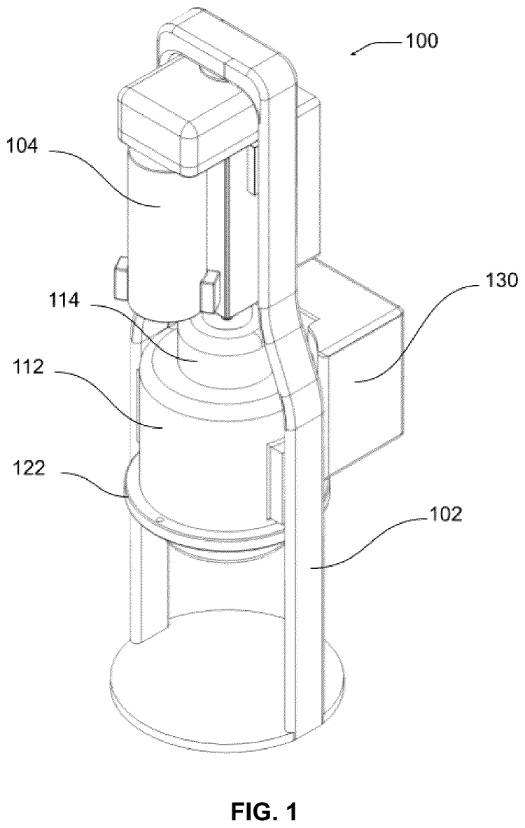

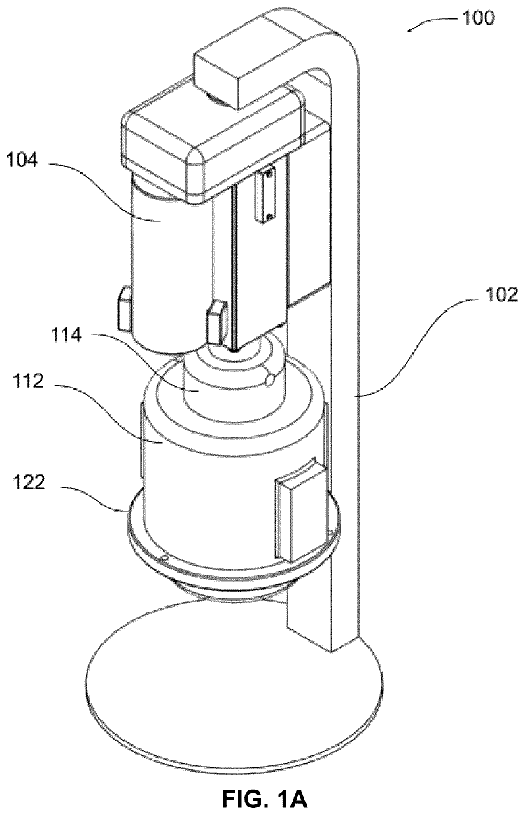

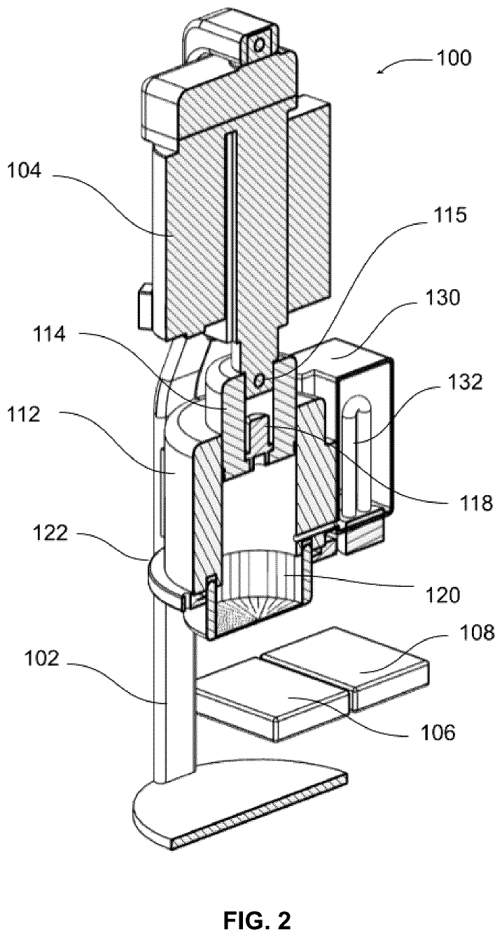

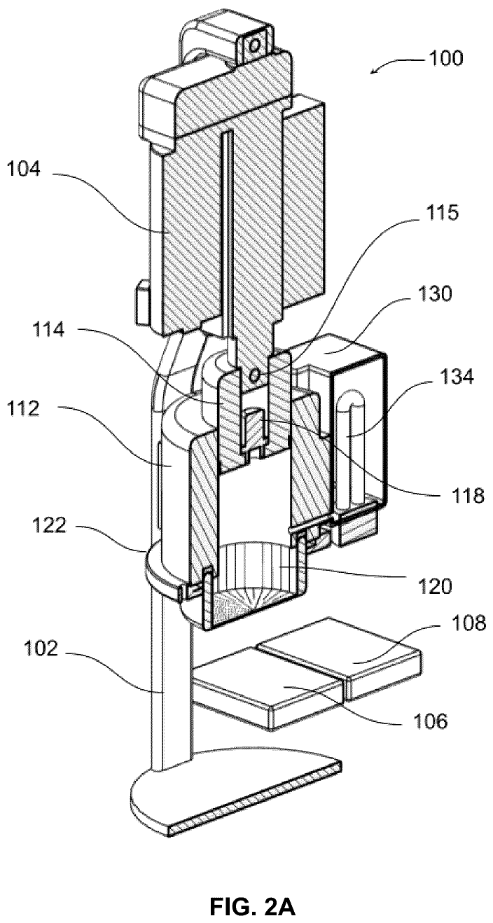

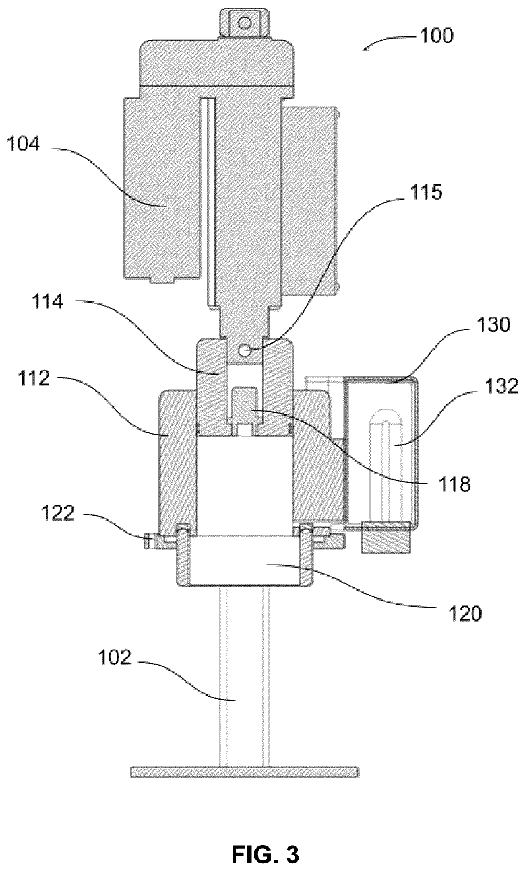

FIG. 1 illustrates an exemplary overall angled view of a pressurized solution extraction system 100. Additionally, FIG. 2 illustrates an exemplary angled overall slice view of the pressurized solution extraction system 100, and FIG. 3 illustrates an exemplary overall slice view of the pressurized solution extraction system 100. The system 100 as shown in the figures includes a solution extraction chamber assembly 110 attached to a frame 102, actuator assembly 104, and solvent container 130. The motor is attached in electronic communication to an actuator controller unit 106. The frame 102 holds the actuator assembly 104 and extraction chamber assembly 110 in axial alignment, such that the actuator assembly 104 applies force to the extraction chamber assembly piston 114 as directed by the actuator controller unit 106. The frame 102 may take any form that satisfies the mechanical requirements of the system 100. A frame 102 may take the form of any combination of the following forms, including but not limited to a column, machined or cast metal body, machined or cast plastic body. A frame 102 will support both the extraction chamber assembly 110 and the actuator assembly 104 in axial alignment, with the whole assembly supported with sufficient clearance below the solute container 120 to allow room for a user to access the solute container 120, and to place a receptacle such as a cup beneath the solute container 120 in order to collect the extractants from the system 100. The ideal embodiment of the system 100 may feature a cylinder 112 or other component that can support the actuator assembly 104 in axial alignment without the use of a separate frame 102.

FIG. 1A illustrates an exemplary angled overall view of a pressurized solution extraction system 100 with a single-leg frame 102. This embodiment allows for better access to the solute container 120 and is optimized for use in accordance with one or more embodiments.

An actuator assembly 104 is any system of motor configured with mechanics to deliver a linear motion. The system 100 as shown incorporates a linear actuator, but implementations of the system may use any mechanism to generate a linear motion in a controlled fashion. This mechanism may take any of a variety of forms, including, but not limited to, a stepper motor paired with ball screw or lead screw, a linear motor, a pneumatic or hydraulic actuator.

An actuator controller unit 106 is any configuration of circuitry or electronics that accepts as input logic-level electronic signals from the microcontroller 108 and provides as output power to a motor, electronic valves, or associated control device in the actuator assembly. The ideal embodiment of this system combines the actuator control unit and microcontroller on one printed circuit board. A printed circuit board is a medium used to connect or “wire” components to one another in a circuit. It takes the form of a laminated sandwich structure of conductive and insulating layers: each of the conductive layers is designed with a pattern of traces, planes and other features etched from one or more sheet layers of copper laminated onto and/or between sheet layers of a non-conductive substrate. Electrical components may be fixed to conductive pads on the outer layers in the shape designed to accept the component's terminals, generally by means of soldering, to both electrically connect and mechanically fasten them to it.

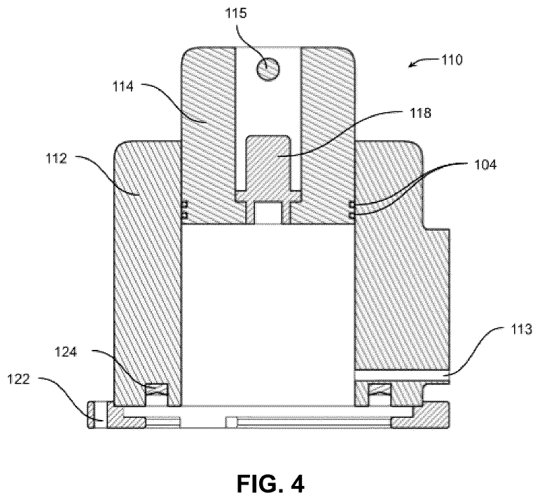

FIG. 4 illustrates an exemplary angled side slice view of the solution extraction chamber assembly 110. An extraction chamber assembly 110 comprises a cylinder 112 and a piston 114, the cylinder 112 having an interior diameter sized to the piston, with a locking mount 122 connected to the opposing end of the cylinder 112 to that of the piston 114. A solute container 120 is shown inserted to the locking ring mount 122 and in pressure contact with the solute container gasket 124.

As shown in FIGS. 1 through 6, the locking ring mount 122 is a separate part from the cylinder 112. Some embodiments of the system 100, the locking ring mount 122 is an integral part of cylinder 112, and comprise one singular component. The locking ring mount 122 and cylinder 112 are separate parts to facilitate maintenance of the system 100. The combination of both components into one single part simplifies the fabrication of the system 100 and some implementations may be constructed in this manner.

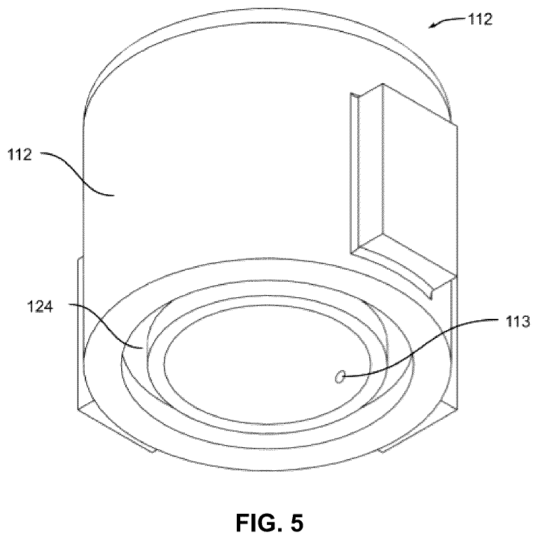

FIG. 5 illustrates a lower angled view of the cylinder 112. The lower face of the cylinder 112 is grooved, and contains a solute container gasket 124. The cylinder 112 features a square cut groove on the bottom face, concentric to the inner wall of the cylinder 112 and sized such that the inner and outer diameter of the groove match the inner and outer diameter of the lip of the solute container 120, respectively. A solute container gasket 124 is set into the groove.

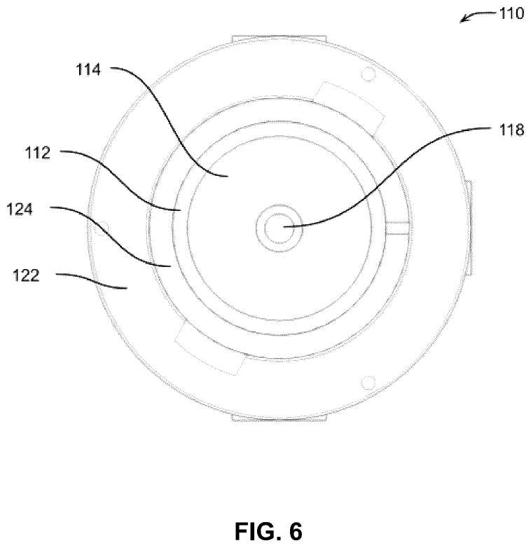

FIG. 6 illustrates an exemplary bottom view of a solution extraction chamber assembly, with locking ring 122 fixed to the cylinder 112. The solute container 120 can be inserted into the locking ring mount 122 when the ears are aligned to the cutouts. When the solute container 120 is rotated, the locking ring mount 122 provides pressure to the solute container 120, holding it in pressure contact with the gasket 124 and cylinder 112 to create a sealed volume.

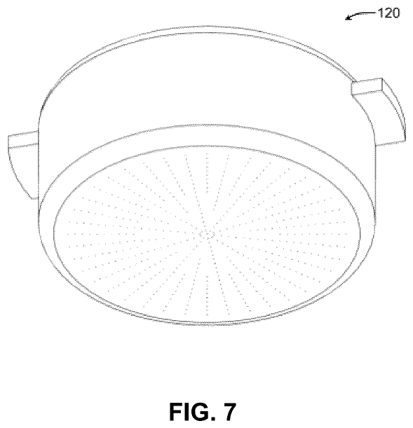

FIG. 7 shows an exemplary lower angled view of the solute container 120, showing a plurality of holes sized such that liquid solution may pass through with restricted flow, but solids remain in the solute container. The size, positioning, and quantity of holes on the bottom surface of the solute container may vary to accommodate varying extractable materials. These properties are critical to the operation of the system 100. If the holes are too large, or too numerous, the system 100 will not be able to generate sufficient pressure. If the holes are undersized or too few in number, the system 100 will suffer from restricted flow. Some embodiments of the solute container 120 feature various configurations of these holes. It is understood that the figures are provided as examples and are not limiting. The solute container 120 is sized with an interior diameter matching that of the cylinder 112, and a depth sufficient to hold an amount of material from which solutes may be extracted. Some embodiments of the solute container 120 feature a different depth to allow the user to extract varying amounts of extractable material, allowing the user to produce a specific quantity or concentration of solution.

The piston 114 is sized to the inner diameter of the cylinder 112, such that no fluids may pass between their surfaces. The piston 114 features a bore sized to the diameter of the actuator assembly 104 shaft, and a hole perpendicular to and intersecting the bore, diametrically matching the actuator assembly 104 shaft pin hole. A pin 115 is set into the hole, fixing the piston 114 to the actuator assembly 104 shaft.

The cylinder 112 features a fill port 113 through which solvent may pass from the solvent container 130 into the extraction chamber assembly 110, but solvent may not pass from the cylinder 112 back to the solvent container 130. The diameter, orientation, position, and quantity of fill ports 113 may vary to account for solvent selection, o-ring 116 positioning, and other operational parameters. The ideal embodiment of this invention features a fill port through the piston 114, allowing solvent to flow directly over the top of the material to be extracted.

The system 100 as shown in FIGS. 2 through 3 illustrate a heating element 132 positioned inside the solvent container 130. In a preferred embodiment the heating element 132 may take the form of an elongated electroconductive metal. This element may be shaped to the application and location, may vary in length, and may vary in wattage output. The heating element 132 inside the solvent container 130 maintains temperature stability of the chosen solvent in accordance with instruction from the microcontroller 108. The ideal embodiment of this invention may operate at a wide range of temperatures and is not limited to use with a heated solvent. Some embodiments of this invention may use any of a variety of solvents including, but not limited to, supercritical fluids, cold fluids, room temperature fluids, alcohols, water, butane and/or any solvent that may be necessary for the extraction of a specific solute from the material of interest. Some embodiments of this invention may use a heat exchanger 134 in place of the heating element 132, which may either heat or cool the solvent. FIG. 2A illustrates a heat exchanger positioned within the solvent container 130. A heat exchanger 134 may be any of a variety of devices that can be used to add or remove heat to the solvent. A heat exchanger 134 may take the form of a tube positioned through the solvent container 130 through which a fluid of a known temperature may flow. By way of conductive heat transfer, heat may flow through the walls of the tube from the fluid or solvent of higher temperature to the fluid or solvent of lower temperature. Through this mechanism, the temperature of the solvent in the solvent container 130 may be controlled. The ideal implementation of the system 100 features a heating element positioned in the extraction chamber assembly 110. The heating element reaches a required temperature as is necessary for the functionality of the system 100 when a desired current runs through it.

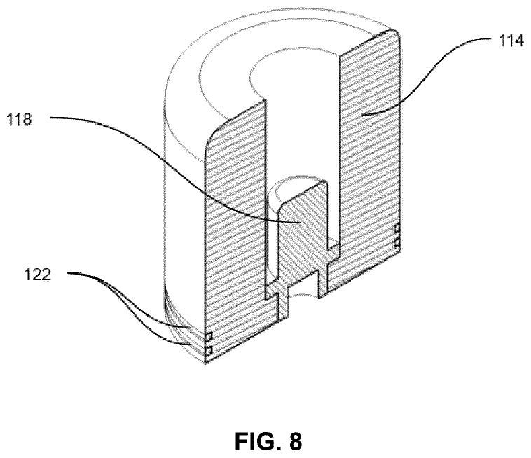

FIG. 8 illustrates an exemplary angled slice view of a piston 114. A plurality of O-rings 116 circumscribe the piston 114 to ensure a sliding seal in the interface of the piston 114 and cylinder 112. The quantity of O-rings 116 and their positions may vary in some embodiments of the system 100 to accommodate different fill placements, drain port placements, solvent characteristics, or operational parameters The thickness, hardness, and other material aspects of the at least one O-ring 116 may vary in order to account for tolerances in the diameter of the cylinder 112 wall, diameter of the piston 114, material selection of the cylinder 112, material selection of the piston 114, selection of solute, selection of solvent, operational temperature, or pressure. One or more embodiments of the system use dissimilar materials for the piston 114 and cylinder 112 if the user is seeking different resistance to corrosion from various solvents, or mechanical properties such as friction or different thermal conductivities. These materials may expand or contract as a result of temperature changes, informing the selection of O-ring 116. O-ring 116 materials vary in resistance to chemical deterioration, offer differing amounts of friction, or resistance to extreme temperature. The choice of operational parameters will inform O-ring 116 selection. The ideal embodiment of this invention allows the user to easily change the O-rings 116.

A pressure sensor 118 is positioned within the piston 114 and in electronic communication with the microcontroller 108, allowing direct contact monitoring of the pressure inside the extraction chamber assembly 110.

The position of the pressure sensor ensures accurate and rapid measurements of the solute/solvent mix to minimize hysteresis in the feedback control loop. Hysteresis is a dynamic lag between an input and an output that disappears if the input is varied more slowly; this is known as rate-dependent hysteresis. In some embodiments of the system 100 the pressure sensor 118 is positioned in the interior wall of the cylinder 112, or in the solute container 120. The pressure sensor 118 may be positioned in any such component that allows direct contact measurement of the solvent and solution mix.

The pressure sensor 118 also functions as a temperature sensor in electronic communication with the microcontroller 108. Use of a combination pressure and temperature probe offers the advantage of accurately correcting for sensor error due to temperature changes. Additionally, the combination of two sensors allows a more compact design with greater ease of assembly.

In some embodiments, a temperature sensor is positioned within the piston 114 and in electronic communication with the microcontroller 108, allowing direct contact monitoring of the temperature inside the extraction chamber assembly 110. The position of the temperature sensor ensures accurate and rapid measurements of the solute/solvent mix to minimize hysteresis in the feedback control loop. In some embodiments of the system 100 the temperature sensor is positioned in the interior wall of the cylinder 112, or in the solute container 120. The temperature sensor may be positioned in any such component that allows direct contact measurement of the solvent and solute mix.

The microcontroller 108 may use one or more algorithms to produce a control signal for the actuator control circuit 106. In some embodiments these algorithms may take any of a variety of forms, including, but not limited to, Proportional (P) control, Integral (I) control, Derivative (D) control, Proportional-integral (PI) control, Proportional-derivative (PD) control, Proportional-integral-derivative (PID) control or any combination thereof.

The microcontroller 108 may be programmed to produce, based on information from the pressure sensor 118, a temperature sensor, or other available sensors or data, an output that is constant, or variable. It is understood that the profile of the resultant output of the microcontroller 108 may take any of a variety of forms, including, but not limited to, linear, sinusoidal, exponential, piecewise, algorithmic, or non algorithmic. The ideal embodiment of this system may produce any combination of profiles.

The ideal embodiment of the system 100 includes a user control interface in communication with the microcontroller 106 and a display connected to the user control interface, the user control interface allowing a user to input at least one parameter and the display showing the parameter to the user.

In the ideal embodiment of system 100, the parameters input by the user may include one or more operational parameters. Operational parameters include, but are not limited to temperature or temperature profile targets, pressure or pressure profile targets, time/duration targets, and start/stop controls. An operational parameter may result in a different pressure or temperature in the extraction chamber assembly 110, or a different timing of the solution extraction process.

In the ideal embodiment of system 100, the parameters input by the user may include one or more tuning parameters. A tuning parameter effects a change to the algorithm used by the microcontroller 106, resulting in a change to the responsiveness of the system. Tuning parameters include, but are not limited to P, I, or D control algorithm coefficients kP, kl, kD, system state variables that define hardware characteristics, and information about system 100 calibration.

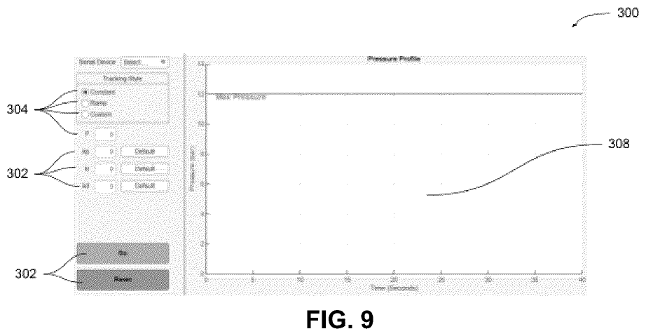

FIG. 9 is a screenshot of an example user interface menu 300. User interface menu 300 is one example of a user interface for system 100. The ideal implementation of user interface 300 may include, but is not limited to keyboard, mouse, display, touchscreen, dedicated buttons, knobs, switches, and sliders.

Submenu 302 displays the selected tuning parameters. The user may select and edit these parameters in accordance with desired operational or tuning parameters, desired system 100 output, amount of solvent, and/or amount of solute. The user may touch, click, press one or more buttons, move one or more sliders, or turn one or more knobs, in accordance with one or more embodiments of user interface menu 300.

Submenu 304 displays the selected operational parameters. The user may select and edit these parameters in accordance with desired operational or tuning parameters, desired system 100 output, amount of solvent, and/or amount of solute. The user may touch, click, press one or more buttons, move one or more sliders, or turn one or more knobs, in accordance with one or more embodiments of user interface menu 300.

Submenu 306 offers start and stop controls. The user may touch, click, press one or more buttons, or flip one or more switches in accordance with one or more embodiments of user interface menu 300.

Submenu 308 offers a graphical representation of the chart of the selected pressure profile, a real-time chart of the pressure within the extraction chamber throughout the extraction process, and an interface for the user to input custom pressure profile targets. The user may click, touch, click and drag, touch and drag, turn one or more knobs, press one or more buttons, flip one or more switches, or move one or more sliders in accordance with one or more embodiments of user interface menu 300.

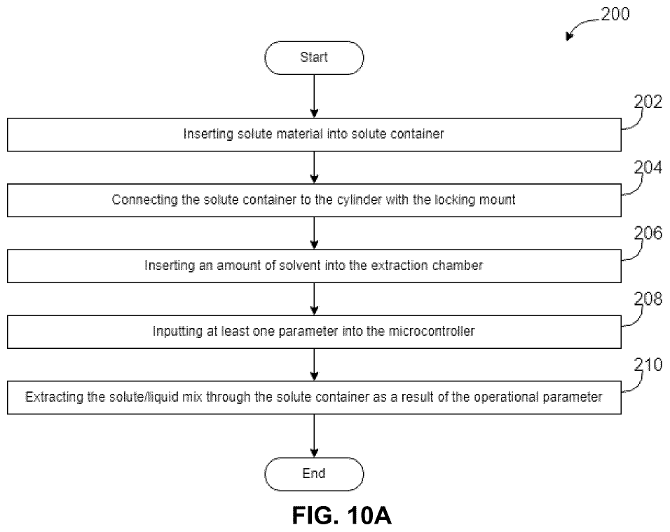

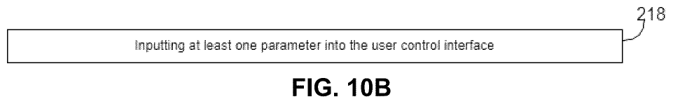

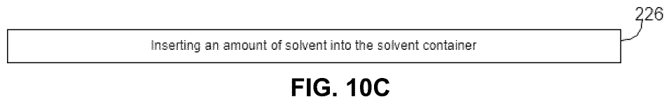

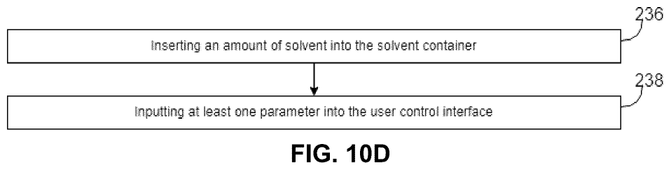

FIGS. 10A, 10B, 10C, and/or 10D illustrate a method 200 of operating a pressurized solution extraction system, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 10A, 10B, 10C, and/or 10D and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 10A illustrates method 200, in accordance with one or more implementations. At step 202 method 200 may include inserting an amount of extractable material into solute container 120 in proportion to the desired output, and size of solute container 120. At step 204 method 200 may include connecting the solute container 120 to the cylinder 112 with the locking mount 122. At step 206 method 200 may include inserting an amount of solvent into extraction chamber assembly 110 in proportion to the desired output, and size of extraction chamber assembly 110. At step 208 method 200 may include inputting at least one parameter into the microcontroller 108 in accordance with desired operational or tuning parameters, desired system 100 output, amount of solvent, and/or amount of solute. At step 210 method 200 may include extracting the solution through the solute container 120 as a result of the operational parameter.

FIG. 10B illustrates method 200, in accordance with one or more implementations. At step 212 method 200 may include inserting solute material into solute container 120 in proportion to the desired output, and size of solute container 120. At step 214 method 200 may include connecting the solute container 120 to the cylinder 112 with the locking mount 122. At step 216 method 200 may include inserting an amount of extractable material into solute container 120 in proportion to the desired output, and size of solute container 120. At step 218 method 200 may include inputting at least one parameter into the user control interface 300 in accordance with desired operational or tuning parameters, desired system 100 output, amount of solvent, and/or amount of solute. At step 220 method 200 may include extracting the solution through the solute container 120 as a result of the operational parameter.

FIG. 10C illustrates method 200, in accordance with one or more implementations. At step 222 method 200 may include inserting an amount of extractable material into solute container 120 in proportion to the desired output, and size of solute container 120. At step 224 method 200 may include connecting the solute container 120 to the cylinder 112 with the locking mount 122. At step 226 method 200 may include inserting an amount of solvent into the solvent container 130 in proportion to the desired output, and size of solvent container 130. At step 228 method 200 may include inputting at least one parameter into the microcontroller 108. At step 230 method 200 may include extracting the solution through the solute container 120 as a result of the operational parameter.

FIG. 10D illustrates method 200, in accordance with one or more implementations. At step 232 method 200 may include inserting an amount of extractable material into solute container 120 in proportion to the desired output, and size of solute container 120. At step 234 method 200 may include connecting the solute container 120 to the cylinder 112 with the locking mount 122. At step 236 method 200 may include inserting an amount of solvent into the solvent container 130 in proportion to the desired output, and size of solvent container 130. At step 238 method 200 may include inputting at least one parameter into the user control interface 300. At step 240 method 200 may include extracting the solution through the solute container 120 as a result of the operational parameter.

As will be appreciated by one skilled in the art, aspects of the present invention may be embodied as a system, method or computer program(s). Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program(s) embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium or data store may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: portable computer diskette, hard disk, read only memory (ROM), optically readable storage media (e.g., CD-ROM, DVD), magnetically readable storage media (e.g., magnetic tape, magnetic hard drive, floppy drive), electrical charge-based storage media or random access memory (e.g., EEPROM, RAM), solid-state storage media (e.g., flash drive, solid-state hard drive), other electronically readable storage media and/or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and/or any suitable combination of the foregoing.

Computer program code for carrying out operations for aspects of the present invention may be written in any combination of one or more programming languages, including: object oriented programming languages such as Java, Smalltalk, C++, conventional procedural programming languages such as the “C” programming language or similar programming languages, scripting language such as Perl, Javascript/Typescript, and/or VBS, functional languages such as Lisp and/or ML, logic-oriented languages such as Prolog, and/or blockchain smart contract languages such as Solidity, Move, Tezos, fi, and/or Plutus. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a virtual private network (VPN), and/or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program(s) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or device provide processes for implementing the functions/acts specified in the flowchart and/or block diagram block or blocks.

The flowchart and block diagrams in the figures illustrate the architecture, functionality, and operation of possible implementations of the system(s), method(s) and computer program(s) according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program(s) may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instruction embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively or may include one or more stand-alone components. The hardware and software components of the computer system of the present disclosure may include and may be included within fixed and portable devices such as desktops, laptops, and/or servers. A module may be a component of a device, software, program, or system that implements some “functionality,” which can be embodied as software, hardware, firmware, and/or electronic circuitry.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

Furthermore, although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A pressurized solution extraction system comprising:
a cylinder and a piston, the cylinder having an interior diameter sized to the piston;
a locking mount sized to the interior diameter of the cylinder, the locking mount connected to the opposing end of the cylinder to that of the piston;
a solute container having a plurality of holes and an interior diameter matching the interior diameter of the cylinder, the solute container configured to be in pressure contact to the end of the cylinder by the locking mount to create a chamber capable of holding a solute/solvent mix, with the cylinder, piston, and solute container comprising an extraction chamber assembly;
a pressure sensor connected to the extraction chamber assembly and capable of taking pressure measurements of the solute/solvent mix within the chamber;
an actuator assembly connected to the extraction chamber assembly, the actuator assembly controlled by an actuator controller unit;
a frame connected to the extraction chamber assembly and actuator assembly, the frame holding the extraction chamber assembly and actuator assembly in axial alignment; and
a microcontroller in electronic communication with the pressure sensor, the microcontroller configured to provide a signal to the actuator controller circuit, with the piston operating in a linear direction through the cylinder to force the solute/solvent mix through the solute container as directed by the microcontroller based on the pressure measurements from the pressure sensor.

2. The pressurized solution extraction system of claim 1, the system further including:
a temperature sensor connected to the extraction chamber assembly and capable of taking temperature measurements of the solute/solvent mix within the chamber.

3. The pressurized solution extraction system of claim 1, system further including:
a user control interface in communication with the microcontroller; and
a display connected to the user control interface, the user control interface allowing a user to input at least one parameter and the display showing the parameter to the user.

4. The pressurized solution extraction system of claim 3, further including:
a solvent container connected to the extraction chamber assembly such that solvent may flow from the solvent container into the extraction chamber; and
a heating element connected to the solvent container and the microcontroller, the heating element further including a second temperature sensor configured to regulate the temperature of the solvent container as a result of instruction by the microcontroller.

5. The pressurized solution extraction system of claim 3, where the parameter constitutes an operational parameter.

6. The pressurized solution extraction system of claim 3, where the parameter constitutes a tuning parameter.

7. The pressurized solution extraction system of claim 5, where the extraction chamber assembly extracts solute from the solvent solute mix at a set target based on the operational parameter.

8. The pressurized solution extraction system of claim 6, where the microcontroller performs tracking calculations with different coefficients based on the tuning parameter.

9. A method of operating a pressurized solution extraction system comprising a cylinder, a piston, a locking mount sized to the interior diameter of the cylinder, a solute container having a plurality of holes and an interior diameter matching the interior diameter of the cylinder, the solute container configured to be in pressure contact to the end of the cylinder by the locking mount to create a chamber capable of holding a solute/solvent mix, with the cylinder, piston, and solute container comprising an extraction chamber assembly, a pressure sensor connected to the extraction chamber assembly and capable of taking pressure measurements of the solute/solvent mix within the chamber; an actuator connected to the extraction chamber assembly, the actuator controlled by an actuator controller unit; and a microcontroller in electronic communication with the pressure sensor, the microcontroller configured to provide a signal to the actuator controller circuit, the method comprising the steps of:
placing a solvent/solute mixture into the solute container;
connecting the solute container to the cylinder with the locking mount;
Inputting at least one parameter into the microcontroller; and
extracting the solute/solvent mix thru the solute container as a result of the operational parameter.

10. The method of claim 9, the system further including a user control interface in communication with the microcontroller and a display connected to the user control interface, the user control interface allowing a user to input at least one parameter and the display showing the parameter to the user, the method further including the step of inputting at least one parameter into the user control interface.

11. The method of claim 9, the system further including a solvent container connected to the extraction chamber assembly such that solvent may flow from the solvent container into the extraction chamber; and a heating element connected to the solvent container and the microcontroller, the heating element further including a second temperature sensor configured to regulate the temperature of the solvent container as a result of instruction by the microcontroller, the method further including the steps of:
Filling the solvent container with a solvent to be used for extraction; and
Inputting desired solvent container temperature to the microcontroller.

12. The method of claim 10, the system further including a solvent container connected to the extraction chamber assembly such that solvent may flow from the solvent container into the extraction chamber; and a heating element connected to the solvent container and the microcontroller, the heating element further including a second temperature sensor configured to regulate the temperature of the solvent container as a result of instruction by the microcontroller, the method further including the steps of:
Filling the solvent container with a solvent to be used for extraction; and
Inputting desired solvent container temperature to the user control interface.

13. The method of claim 10, where the parameter constitutes an operational parameter.

14. The method of claim 10, where the parameter constitutes a tuning parameter.

15. The method of claim 13, the method further including the step of setting a target based on the operational matter.
